(19) United States
(12) Patent Application Publication
(10) Pub. No.: US 2007/0068551 A1
(43) Pub. Date: Mar. 29, 2007

(54) Squirter jet ultrasonic cleaning

(76) Inventor: Balaji Rao Garimella, Glendale Park (SG)

Correspondence Address: CARLSON, GASKEY & OLDS, P.C., 400 WEST MAPLE ROAD, SUITE 350, BIRMINGHAM, MI, 48009, US

(21) Appl. No.: 11/284,642

(22) Filed: Nov. 22, 2005

(30) Foreign Application Priority Data
Sep. 29, 2005 (SG) 200506306-0

(51) Int. Cl. B08B 3/12; B08B 9/00; B08B 3/00; B08B 9/093

(52) U.S. Cl. 134/1; 134/22.1; 134/22.18; 134/184; 134/166 R; 134/168 R

(57) ABSTRACT

A method and device for cleaning a hollow article and specifically a turbine blade assembly utilizes a cleaning solution flowed through the turbine blade assembly and a transducer that generates an ultrasonic frequency that is transmitted through the flowing cleaning solution to the internal surfaces of the turbine blade. Ultrasonic waves emitted by the transducer generate energy that is transmitted through the cleaning solution within the internal cavity and against interior surfaces of the turbine blade. Ultrasonic waves that contact the internal surfaces dislodge and remove dirt and grim.

### REFERENCE TO RELATED APPLICATION

This application claims priority to Singapore Patent Application No. 200506306-0 which was filed on Sep. 29, 2005.

### BACKGROUND OF THE INVENTION

This invention relates generally to the cleaning of turbine blades. More specifically this invention relates to a method and device for cleaning internal surfaces of a turbine blade.

Typically, a turbine blade is thoroughly cleaned prior to repair and reconditioning. The internal cavities are difficult to clean and require a tedious and time-consuming process. Conventional cleaning of turbine blades includes the use of an ultrasonic cleaning method. The conventional ultrasonic cleaning method utilizes a transducer that emits an ultrasonic high frequency wave into a cleaning solution filled tank. Energy from the transducer is transmitted through the tank walls into the liquid cleaning solution. The ultrasonic wave travels through the cleaning solution to the outer surface of the turbine blade. A portion of the ultrasonic wave is then transmitted through the turbine blade to the inner surfaces. The ultrasonic wave then loosens and dislodges dirt from the inner surface.

Disadvantageously, the many surfaces and mediums that energy must travel through reduce the amount of energy actually present within the turbine blade to clean away dirt. Energy is drained and absorbed by the tank walls, the cleaning solution and the turbine blade such that only a small portion of energy emitted from the transducer actually reaches the inner surfaces of the turbine blade. The resulting process is inefficient and time consuming. Further, because only a portion of energy actually penetrates the turbine blade to clean the interior surfaces, a very high level of energy is required. The high amount of energy impacts the outer surfaces of the turbine blade potentially distorting delicate features and edges of the turbine blade.

Accordingly, it is desirable to develop a process and device for cleaning interior surfaces of the turbine blade that does not require excessive amounts of energy, decreases cleaning time and reduces any potential damage to exterior surfaces.

### SUMMARY OF THE INVENTION

This invention is a method and device for cleaning internal surfaces of a turbine blade without contacting exterior surfaces. The method utilizes a transducer in combination with a flow of cleaning solution through the turbine blade to clean internal surfaces of the turbine blade.

The device and method according to this invention includes a cleaning solution that is flowed through a turbine blade and a transducer that generates an ultrasonic wave through the flowing cleaning solution. Cleaning solution is directed to flow through the internal cavity of the turbine blade without contacting exterior surfaces. The transducer is submerged within the cleaning solution and generates an ultrasonic wave that is carried with the flowing cleaning solution through the turbine blade. The turbine blade is not submerged within the cleaning solution. Generation of the ultrasonic wave within the flowing cleaning solution removes dirt and other build up from the internal surfaces of the turbine blade without contacting exterior surfaces.

Accordingly, the method and device for cleaning and reconditioning a turbine blade assembly according to this invention provides for cleaning of the interior surfaces of the turbine blade without excessive energy in a shorter time period without contacting exterior surfaces of the turbine blade assembly.

These and other features of the present invention can be best understood from the following specification and drawings, the following of which is a brief description.

### BRIEF DESCRIPTION OF THE DRAWINGS

FIG. 1 is a schematic representation of a turbine blade and a cleaning assembly according to this invention.

FIG. 2 is an enlarged view of a portion of the nozzle and transducer mounted to the turbine blade.

FIG. 3 is a schematic representation of a turbine blade and mask for protecting an exterior surface of the turbine blade.

FIG. 4 is a schematic representation of a fixture for cleaning multiple turbine blades.

FIG. 5 is a flow diagram illustrating the method steps for cleaning a turbine blade according to this invention.

### DETAILED DESCRIPTION OF THE PREFERRED EMBODIMENT

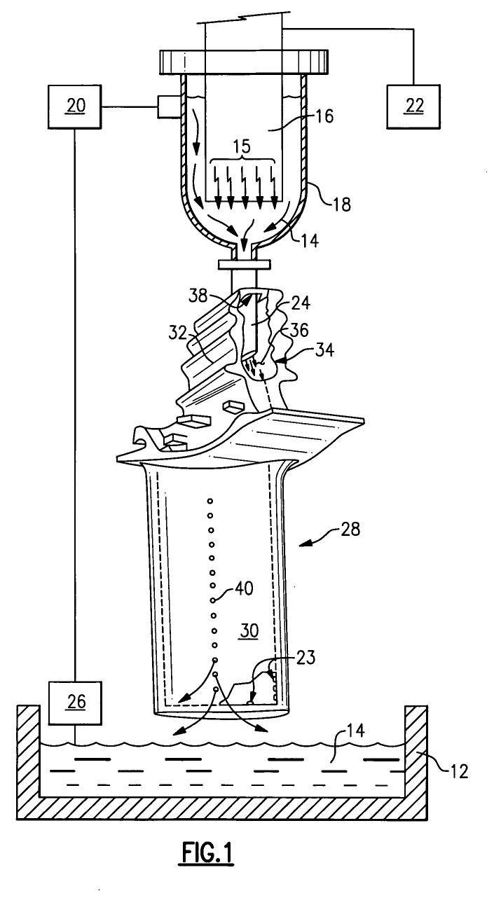

Referring to FIG. 1, a cleaning assembly 10 for cleaning a hollow article includes a tank 12 filled with a cleaning solution 14. The cleaning solution 14 is preferably comprised of a 30-45% concentration of potassium hydroxide. Although, a specific amount and type of cleaning solution is specified in this disclosure other concentrations and mixtures of cleaning solution are within the contemplation of this invention. The cleaning assembly 10 further includes a transducer 16 mounted within a flow body 18. The transducer 16 is of the type that emits a high frequency ultrasonic wave. The flow body 18 includes a nozzle 24 to direct flow of cleaning solution 14 into the hollow article. The transducer 16 is controlled by a controller 22 to generate the desired frequency of ultrasonic waves.

In the illustrated example the hollow article is a turbine blade 28 including a cavity 34 having inner surfaces 36. The nozzle 24 is inserted within the cavity 34 of the turbine blade 28. Cleaning solution 14 is pumped from the tank 12 by a pump 26 through a flow control device 20 into the flow body 18. Cleaning solution 14 is then directed into the cavity 34 of the turbine blade 28 through the nozzle 24. The transducer 16 generates ultrasonic waves 15 that are transmitted through the cleaning solution 14 to the internal surfaces 36 of the turbine blade 28. The ultrasonic waves travel within the cavity 34 that removes dirt and other contaminants that have been adhered to the interior surfaces 36 of the turbine blade assembly 28.

The turbine blade 28 includes a root section 32 and a blade portion 30. The cavity 34 extends from the root section 32 into the blade portion 30. The blade portion 30 includes a plurality of openings 40. The root section 32 includes an opening 38 through which the nozzle 24 is inserted. The cleaning assembly 10 utilizes ultrasonic waves to clean dirt and grim, generally indicated at 25 that builds within the interior surfaces 36 of the turbine blade 28.

The example transducer 16 illustrated includes a power of around 300 watts. Other transducers having different power rating are within the contemplation of this invention. The ultrasonic wave generated by the transducer 16 travels through the cleaning solution 14 to contact the interior surfaces 36 of the turbine blade 28. The exterior surface of the turbine blade 28 is not exposed to the cleaning solution 14 and therefore is not subject to the ultrasonic waves emitted by the transducer 16.

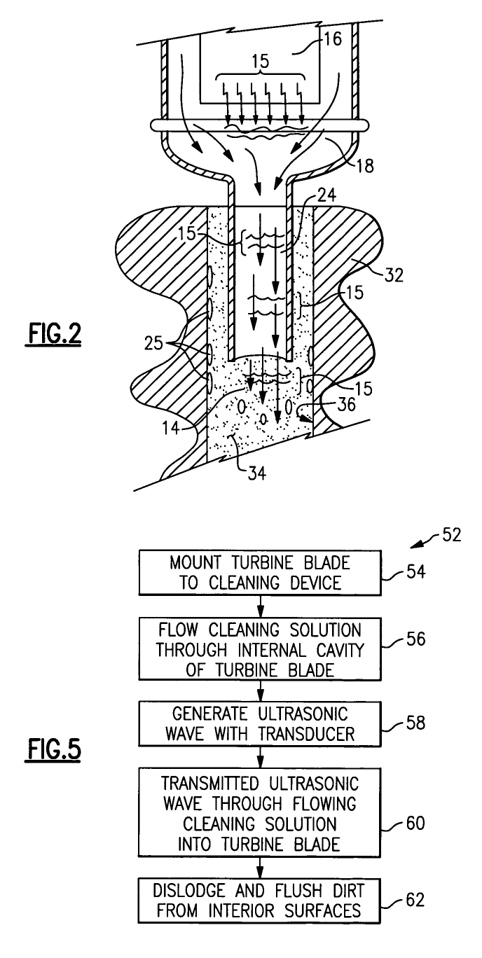

Referring to FIG. 2, an enlarged view of the nozzle 24 disposed within the cavity 34 of the turbine blade 28 is shown. The nozzle 24 is inserted into the cavity 34 a sufficient distance so that it may efficiently distribute cleaning solution 14 to the internal surfaces 36 of the cavity 34. Energy generated from the transducer 16 is emitted and transferred through the cleaning solution 14 against the interior surfaces 36 of the cavity 34. This vibration and ultrasonic frequency that is transmitted through the cleaning solution 14 provides for the loosening and vibration of dirt, schematically indicated at 25 so that it may be removed and flushed from the turbine blade 28.

This specific configuration and shape of the nozzle 24 is designed and developed to fit within the opening 38 of the turbine blade 28. Other shapes as required by application specific requirements are also within the contemplation of this invention. The opening 38 in this instance is slot shaped. Thereby the nozzle 24 is a corresponding generally rectangular shaped member that directs cleaning solution 14 into the turbine blade 28 and transmits ultrasonic energy from the transducer 16 through the cleaning solution 14 to remove the dirt 25 from the interior surfaces 36 of the turbine blade 28.

Referring to FIG. 3, the turbine blade 28 is shown with the root section 32. The root section 32 includes an exterior surface. In some instances it may be desirable to clean a plurality of turbine blades 28 at the same time. A mask 42 is provided with a cavity 44. The cavity 44 fits and is designed to accommodate the root section 32 of the turbine blade 28. The mask 42 serves not only to protect the exterior surface of the turbine blade 28 during cleaning but also as a mounting block for mounting within a cleaning fixture 46.

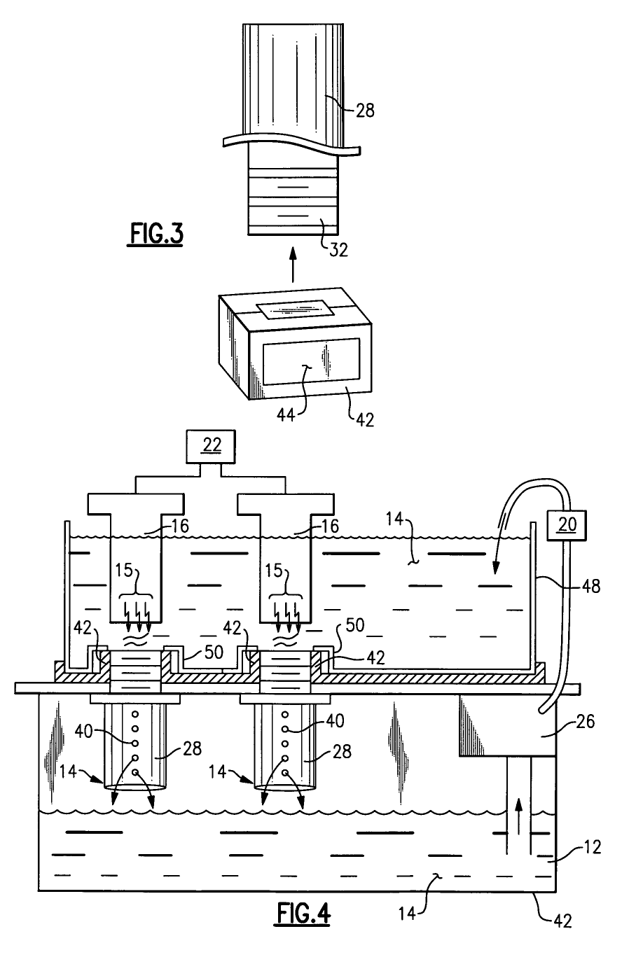

Referring to FIG. 4, the cleaning fixture 46 includes a tank 48. Attached to the tank 48 are the masks 42. The masks 42 are first assembled to each of the turbine blades 28 and then secured to the tank 48 by way of a plurality of brackets 50. The brackets 50 hold each turbine blade 28 in a desired orientation such that the transducer 16 can be orientated relative to the opening 38 within each turbine blade 28. Each turbine blade 28 is suspended above cleaning solution 14 disposed in the tank 12 below. Accordingly, the exterior surface of the turbine blade 28 is not exposed to the cleaning solution or to the ultrasonic waves generated by the transducers 16.

Cleaning solution 14 is pumped from the tank 12 by pump 26 back into the tank 48. The cleaning solution 14 then flows through openings within each of the turbine blades 28 back into the tank 12. A transducer 16 is orientated over each turbine blade 28 and generates ultrasonic waves 15 that are transmitted and carried by the flowing cleaning solution 14 into and through each turbine blade 28. In this way, the cleaning assembly 10 according to this invention utilizing both flowing cleaning solution 14 and ultrasonic waves 15 to dislodge dirt and other build up from internal features of the turbine blade 28.

Referring to FIG. 5, the method according to this invention is schematically illustrated and includes the first step of mounting the turbine blade 28 to the cleaning device 10. The example cleaning device 10 may include the flow body 18 for cleaning a single turbine blade 28 or the cleaning fixture 46 for cleaning multiple turbine blades 28 at the same time. The mounting step is indicated at 54 and also includes the orientation of the transducer 16 relative to an opening within the turbine blade 28.

Once mounted within the cleaning assembly 10, cleaning solution 14 as indicated at 56, is flowed through the turbine blade 28. The cleaning solution 14 utilized in the example embodiment is of a 30-45% concentration of potassium hydroxide. As appreciated, it is within the contemplation of this invention to utilize other concentrations and types of cleaning solutions.

The transducer 16 emits an ultrasonic wave at a pre-determined and desired frequency as indicated at 58. The pre-determined frequency utilizes much less energy then is required when the transducer 16 is utilized to transmit energy through a turbine blade 28. Because the ultrasonic waves are transmitted through the cleaning solution 14 to the interior surfaces of the turbine blade 28 as is indicated at step 60, much less power can be utilized. In instances where ultrasonic cleaning is used to clean internal surfaces where a transducer is used outside of the turbine blade assembly 28 upwards of 6 kilowatts of energy may be required. In the method according to this invention, because the transducer 16 is inserted within the cavity 34 of the turbine blade assembly 28 a much lower power, of about 0.3 kilowatts is all that is required. Other levels of power may be utilized depending on the specific application and level of contamination and dirt adhere to the interior surfaces 26 of the turbine blade 28.

In the example cleaning assembly 10, a pump 26 is installed within the cleaning tank 12. The pump 26 provides for recirculation of the cleaning solution 14. In this application the cleaning solution 14 is pumped through the first opening 38 and then out openings 40 that are disposed within the blade section 30 of each turbine blade assembly 28. The flow of the cleaning solution 14 along with the ultrasonic energy that is transmitted to the interior surfaces 36 of the cavity 34 affect a desired cleaning that removes substantially all of the dirt and grim that have built up over use as is indicated at step 62.

The improved cleaning with the lower amount of energy increases the efficiency and reduces the amount of time required to clean each turbine blade. Prior art methods required days to clean the blades efficiently. The instant invention can clean within hours. Further, because ultrasonic energy is introduced on the internal surfaces within the turbine blade assembly 28, outer surfaces are protected from possible harmful effects of exposure to ultrasonic waves. As appreciated in prior art methods where extreme high power is required to transmit ultrasonic energy through the turbine blade assembly. Outer surface, sharp edges, and delicate surfaces of the turbine blade assembly were susceptible to damage.

Accordingly, the method and device of this invention provides an improved cleaning method that quickly and efficiently cleans turbine blades with much less power and less possibility of potential damage to desirable and delicate external features.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of cleaning an interior surface of a hollow article comprising the steps of:
a) flowing a cleaning solution through the hollow article;
b) emitting an ultrasonic wave through an opening within the hollow article; and
c) transferring energy through the flowing cleaning solution and against the interior surface of the hollow article to remove unwanted material.

2. The method as recited in claim 1, including the step of mounting the hollow article such that an exterior surface remains unexposed to the cleaning solution.

3. The method as recited in claim 1, including the step of mounting a mask on an exterior surface of the hollow article and mounting the hollow article by way of the mask.

4. The method as recited in claim 1, including the step of mounting a transducer adjacent the opening to generate the ultrasonic wave.

5. The method as recited in claim 4, including mounting a flow body having a nozzle within the opening of the hollow article.

6. The method as recited in claim 5, wherein the transducer is submerged within cleaning solution within the flow body.

7. The method as recited in claim 1, wherein the cleaning solution comprises at least some potassium hydroxide.

8. The method as recited in claim 1, wherein the hollow article comprises a turbine blade having the opening within a root section and at least a partially hollow blade portion having at least one opening.

9. The method as recited in claim 8, including the step of flowing cleaning solution through the opening in the root section and out the at least one opening in the blade portion.

10. A cleaning assembly for removing dirt from a cavity of a turbine blade comprising;
a flow body containing a cleaning solution; and
a transducer disposed within the flow body to generate an ultrasonic wave within the cleaning solution that is transmitted through an opening within the turbine blade to agitate and remove dirt from interior surfaces of the cavity.

11. The assembly as recited in claim 10, wherein the flow body includes a nozzle mountable through the opening and into the cavity of the turbine blade to direct flow of cleaning solution within the turbine blade.

12. The assembly as recited in claim 10, including a mask mountable to an exterior portion of the turbine blade to protect the exterior portion of the turbine blade.

13. The assembly as recited in claim 10, wherein the transducer comprises a transducer that emits an ultrasonic wave of a desired frequency that is transmitted through the cleaning solution.

14. The assembly as recited in claim 13, wherein the turbine blade includes blade openings, and cleaning solution is exhausted through the openings within the blade.

15. The assembly as recited in claim 13, wherein the transducer comprises a power of approximately 0.3 kilowatt transducer.

16. The assembly as recited in claim 13, including a fixture for mounting a plurality of turbine blades and a corresponding plurality of transducers adjacent each of the plurality of turbine blades.

17. A method of reconditioning a turbine blade having a root opening and at least one blade opening, said method comprising the steps of:
a) flowing a cleaning solution through an internal cavity of the turbine blade;
b) emitting an ultrasonic wave through the cleaning solution against an interior surface of the turbine blade; and
c) exhausting the cleaning solution from the turbine blade through the at least one blade opening.

18. The method as recited in claim 17, including mounting a portion of a transducer adjacent the root opening to direct the ultrasonic wave against the interior surfaces of the turbine blade.
